(19) United States
(12) Patent Application Publication
(10) Pub. No.: US 2016/0239964 A1
(43) Pub. Date: Aug. 18, 2016

(54) Dot Counting Service

(71) Applicants: Matthew Haugen, Bellevue, WA (US); James Haugen, Bellevue, WA (US)

(72) Inventors: Matthew Haugen, Bellevue, WA (US); James Haugen, Bellevue, WA (US)

(21) Appl. No.: 15/045,221

(22) Filed: Feb. 16, 2016

Related U.S. Application Data
(60) Provisional application No. 62/115,639, filed on Feb. 13, 2015.

(51) Int. Cl. G06T 7/00; G06K 9/00; G06K 9/62; G06T 7/40; G06K 9/46

(52) U.S. Cl. CPC G06T 7/0012; G06T 7/0051; G06T 7/408; G06K 9/4661; G06K 9/6202; G06K 9/00127; G06T 2207/30024; G06T 2207/30242

(57) ABSTRACT

A dot counting service may mark and count each shape it identifies in an image, allowing a user to select other candidate shapes or remove shapes identified in error. A dot counting service may display a running count of identified shapes, or may count them after they have all been identified.

### FIELD

This disclosure relates generally to a dot counting service.

### BACKGROUND

Medical research often requires counting a number of cells in an image. For example, a photo may show a number of red blood cells, which may need to be counted, with the count compared across samples.

Counting cells may be a very tedious project, and is often subject to error. Identifying cells in an image with poor contrast or uneven lighting may be a very tiring task, and counting hundreds or even thousands of identified cells may exhaust a person, which may generate additional errors.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a Dot Counting Service. In one embodiment, it may comprise a software application which may identify objects, such as cells, in an image. Dot Counting Service may mark and count each cell it identifies, allowing a user to select other candidate cells or remove cells identified in error. Dot Counting Service may display a running count of identified cells, or may count them after they have all been identified. In one embodiment, Dot Counting Service may mark each candidate cell with a dot, allowing a user to easily see which items have been identified as cells, and allow the user to click on a location on a displayed image to add or remove a dot.

Dot Counting Service may use one or more ways to identify cells, for example comparing red-green-blue (RGB) values of a displayed pixel to a determined value to determine whether the pixel belongs to a cell or not.

### BRIEF DESCRIPTION OF THE DRAWINGS

FIG. 1 is a block diagram illustrating an example of a system capable of supporting a Dot Counting Service, according to one embodiment.

FIG. 2 is a flow diagram illustrating a Dot Counting Service process according to one embodiment.

FIG. 3 is a sample image which may be processed by Dot Counting Service, according to one embodiment.

FIG. 4 is a sample image being processed by Dot Counting Service, according to one embodiment.

FIG. 5 illustrates a screen shot for an application supporting a Dot Counting Service, according to one embodiment.

FIG. 6 illustrates a screen shot for an application supporting a Dot Counting Service, according to one embodiment.

FIG. 7 is a component diagram of a computing device to which a Dot Counting Service process may be applied according to one embodiment.

Like reference numerals are used to designate like parts in the accompanying drawings.

### DETAILED DESCRIPTION

The instant application discloses, among other things, a Dot Counting Service. In one embodiment, it may comprise a software application which may identify objects, such as cells, in an image. Dot Counting Service may mark and count each cell it identifies, allowing a user to select other candidate cells or remove cells identified in error. Dot Counting Service may display a running count of identified cells, or may count them after they have all been identified. In one embodiment, Dot Counting Service may mark each candidate cell with a dot, allowing a user to easily see which items have been identified as cells, and allow the user to click on a location on a displayed image to add or remove a dot.

Dot Counting Service may use one or more ways to identify cells, for example comparing red-green-blue (RGB) values of a displayed pixel to a determined value to determine whether the pixel belongs to a cell or not.

Many of the attendant features may be more readily appreciated as they become better understood by reference to the following detailed description considered in connection with the attached drawings.

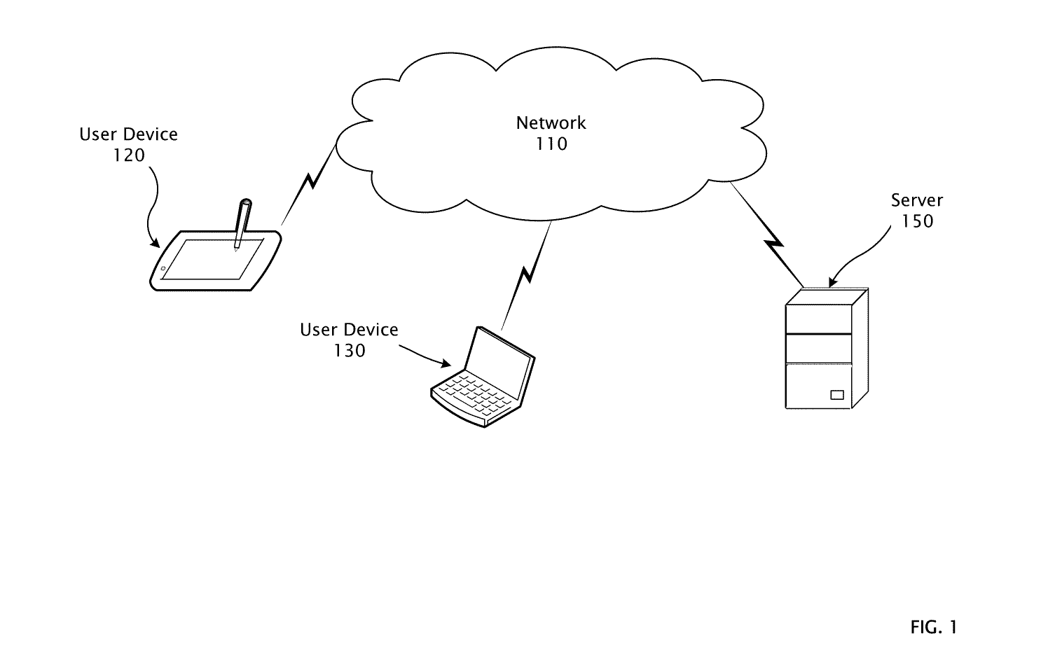

FIG. 1 is a block diagram illustrating an example of a system capable of supporting a Dot Counting Service, according to one embodiment. Network 110 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 110 may comprise Ethernet connectivity. In another embodiment, Network 110 may comprise fiber optic connections.

User Device 120, 130 may be a smartphone, tablet, laptop computer, smart watch or intelligent eyewear, or other device, and may have network capabilities to communicate with Server 150. Server 150 may include one or more computers, and may serve a number of roles. Server 150 may be conventionally constructed or may be of a special purpose design for processing data obtained from a Dot Counting Service. One skilled in the art will recognize that Server 150 may be of many different designs and may have different capabilities.

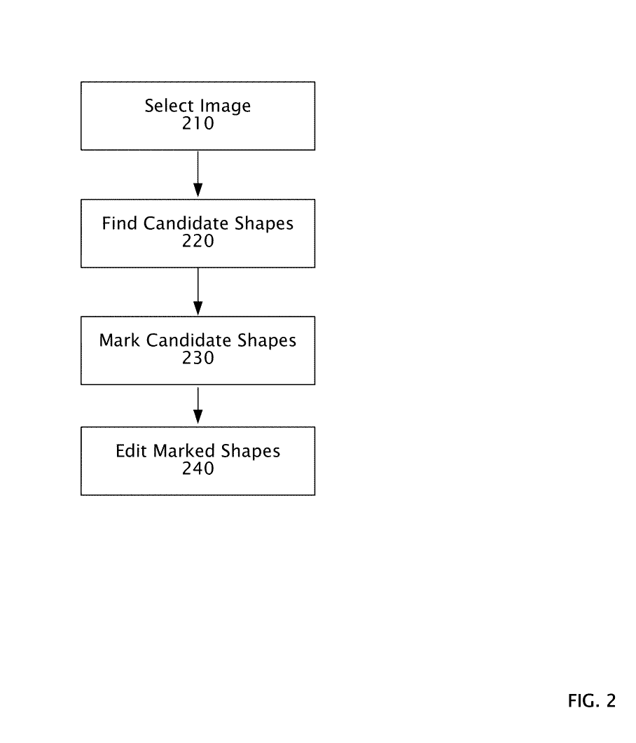

FIG. 2 is a flow diagram illustrating a Dot Counting Service process according to one embodiment. At Select Image 210, a user may be prompted to select an image to process.

Find Candidate Shapes 220 may use one or more algorithms to locate shapes of interest from the image. In one embodiment, a number of points may be selected to represent background levels in various areas of the image, while another set of points may be selected to represent foreground levels. These sets of points may be selected by determining a grid, for example 50 pixels wide by 50 pixels high. Pixels making up a 50-pixel row of the image may be evaluated for an attribute, for example a red value (0-255) of an RGB value for each pixel. In another embodiment, an overall value for brightness may be calculated. A pixel having a lowest value of the 50 pixels may be considered as a background pixel, while a pixel having a highest value may be considered as a foreground pixel. This process may be repeated for an entire row of the image, and repeated for each row corresponding to the 50-pixel height, resulting in a set of approximately four background values and foreground values for each 50×50 pixel section.

Each pixel may then be evaluated with respect to one or more of the nearest pre-determined background and foreground values. The pixels may be considered foreground, for example, if the red value of the image is closer to the red value of the nearest foreground pixel then it is to the nearest background pixel. In another embodiment, a weighting may be used, so that, for example, a pixel may be evaluated as foreground if it is within two-thirds of the nearest foreground pixel in the range between the nearest background pixel and the nearest foreground pixel. In other embodiments, two, three, or more of the nearest foreground or background pixels may be used, for example, by taking an average of the relevant values. In yet another embodiment, multiple nearest foreground pixels may be averaged with an exception of any outliers. Similarly, nearest background pixels may be averaged, with outliers being excluded in certain cases. One having skill in the art will recognize that many ways may be used to select appropriate foreground or background representative pixels.

In another embodiment, pixels may be reviewed and an attribute evaluated by determining a slope of a line representing the attributes' values for two or more pixels. For example, a line may be calculated using a linear regression algorithm based upon RGB values. A slope may be determined for the line, and, if the slope exceeds a threshold value, it may be determined that a foreground shape has been found. Similarly, when the slope falls below a second threshold value, it may be determined that the foreground shape has ended. In one embodiment, pixels may be selected using a sliding window along one row.

In yet another embodiment, an area under the curve approach may be used. A number of points may be selected to represent background levels in various areas of the image, while another set of points may be selected to represent foreground levels. These sets of points may be selected by determining a grid, for example 100 pixels wide by 100 pixels high. Pixels making up a 100-pixel row of the image may be evaluated for an attribute, for example brightness value for each pixel. A pixel having a lowest value of the 100 pixels may be considered as a background pixel, while a pixel having a highest value may be considered as a foreground pixel. This process may be repeated for an entire row of the image, and repeated for each row corresponding to the 100-pixel height, resulting in a set of approximately four background values and foreground values for each 100×100 section.

An attribute of a pixel, for example, a brightness value, may be compared with a value of the same attribute of another pixel, for example, an adjacent pixel. In another embodiment, the brightness value of a pixel may be compared with an average of a lowest five brightness values for 50 pixels in a sliding window of the most recent pixels of a row. A nearest foreground and nearest background value may be determined from the grid previously determined. If the brightness of the pixel exceeds the average added to the difference between the foreground and background sample point brightnesses divided by three, the pixel may be part of the foreground.

One having skill in the art will recognize that various grid sizes and various attributes may be used to determine foreground pixels.

At Mark Candidate Shapes 230, shapes identified as foreground shapes may be marked with a dot, for example, and a count of marked shapes may be maintained. A foreground shape may be identified by any set of contiguous pixels identified as foreground pixels.

At Edit Marked Shapes 240, a user may identify further shapes as foreground shapes. The user may also unmark shapes previously identified as foreground shapes. Dot Counting Service may also maintain a count of shapes manually added or removed.

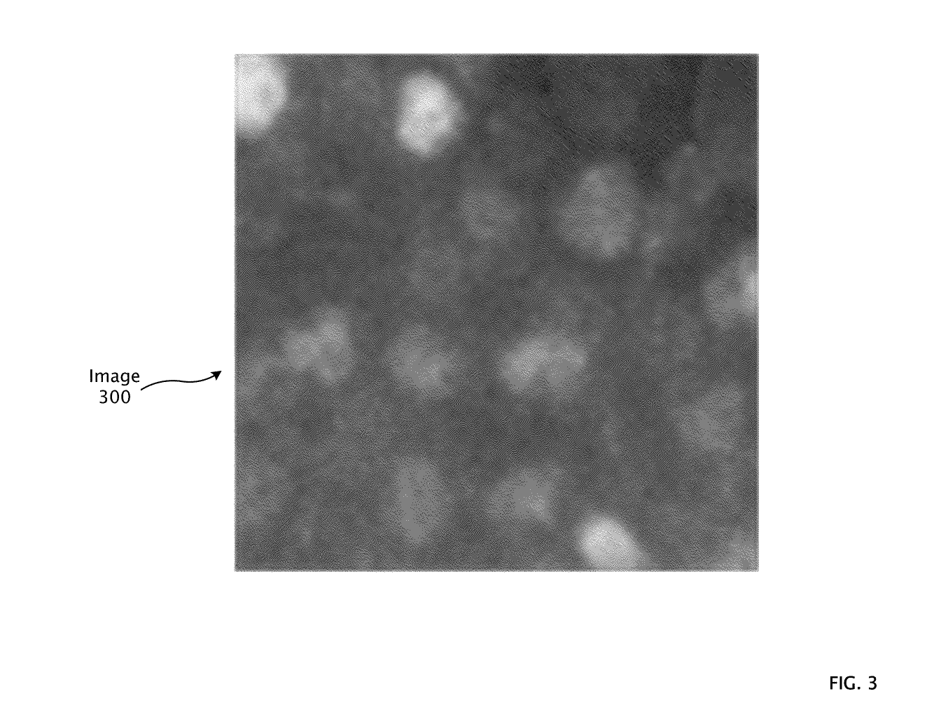

FIG. 3 is a view of an Image 400 to be analyzed by Dot Counting Service. This image is a portion of a picture of a retina converted to grey scale. Red blood cells may be seen as white shapes, and Dot Counting Service determines which parts of Image 400 are red blood cells (foreground), and which parts are background.

Image 400 has varying contrast in different sections, so that background in one section of Image 300 may be lighter than foreground in another section.

In another embodiment, background pixels may be brighter than foreground pixels.

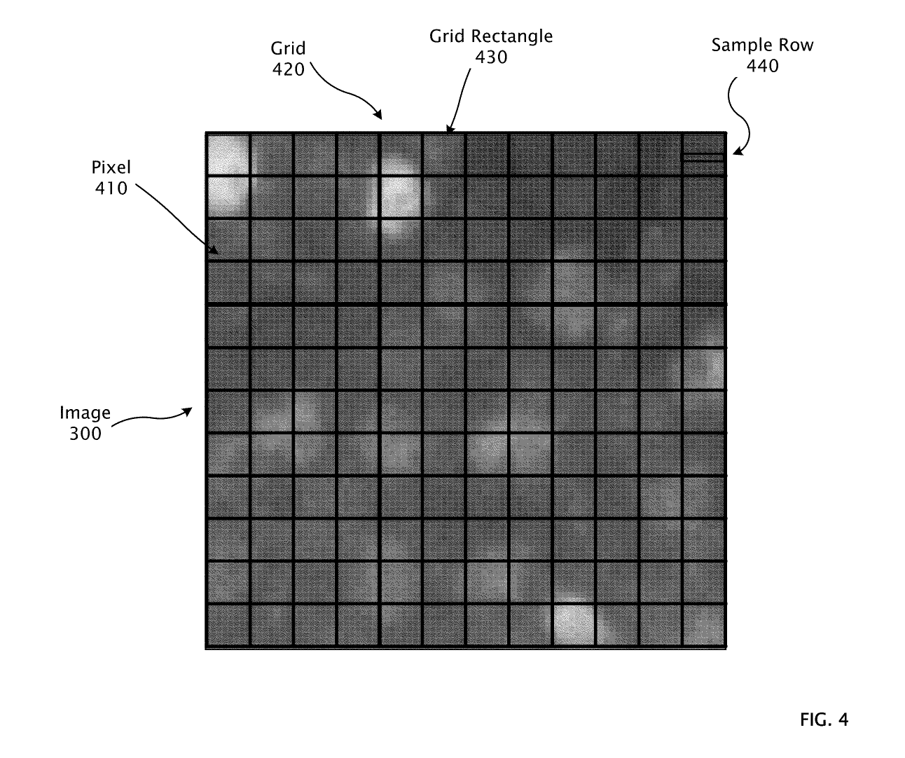

FIG. 4 is a view of Image 300 being processed by Dot Counting Service. Image 300 may be loaded into memory, and may be made up of a plurality of Pixels 410. Each Pixel 410 may have one or more numeric values associated with it. For example, it may have a color value made of three integers for each of red, green, and blue (RGB). The values may each have a range of 0 to 255, for example. Other values may also be used. A brightness value may be calculated from RGB values using formulas known in the industry. A pixel may also have other types of attributes associated with it.

Dot Counting Service may be used, for example, to determine which Pixels 410 belong to red blood cells (foreground) and which are background.

Dot Counting Service may apply Grid 420 to Image 300, with each Grid Rectangle 430 containing a plurality of Pixels 410. Representative values of foreground and background attributes for Grid Rectangle 430 may be determined. For example, a sample of Pixels 410 may be selected in each Grid Rectangle 430; in this example, Sample Row 440. In other embodiments, a sample column may be selected, or a random sampling of Pixels 410 within Grid Rectangle 430 may be used. In yet another embodiment, each pixel within Grid Rectangle 430 may be evaluated. The selected pixels may be evaluated and, for example, a brightest pixel may be selected as a foreground value, while the least bright may be selected as a background value. In a Grid Rectangle 430, one or more pixel values may be selected as representative foreground and one or more pixel values may be selected as representative background. In another embodiment, an average of a plurality of pixel values may be used as a representative background reference value. In yet another embodiment, a moving average may be used as a line of pixels is being processed. For example, a buffer of 50 pixel values may be sorted to provide the five lowest values, which may be averaged to determine a background reference value. As processing continues along a line of pixels, the buffer may drop an oldest pixel value and add a new pixel value, recalculating the background reference value.

Once representative foreground and background reference pixel values are selected within for a Grid Rectangle 430, each Pixel 410 may be compared to those values, and assigned as either foreground or background. This assignment may be made based on which of the foreground and background values is closer to the value of Pixel 410, or the differences may be weighted. For example, if the foreground pixel has a value of 200, the background pixel has a value of 50, and Pixel 410 has a value of 150, Pixel 410 may be considered to be a member of the foreground set. In another embodiment, if the value of Pixel 410 exceeds the average added to the difference between the foreground and background sample point values divided by three, the pixel may be considered to be part of the foreground. In yet another embodiment, a threshold value may be determined between the brightest and darkest Pixel 410 on a current row of a Grid Rectangle 430. The threshold value may be the difference between brightness values of the reference pixels, or may be calculated, for example, the difference divided by three.

One having skill in the art will recognize that various methods may be used to determine which pixels are part of the foreground and which are part of the background. In one embodiment, four pixels may be selected as representative of foreground and four pixels may be selected as representative of background in each grid rectangle. Each pixel in the grid rectangle may then be compared to the nearest foreground and nearest background pixel attribute values.

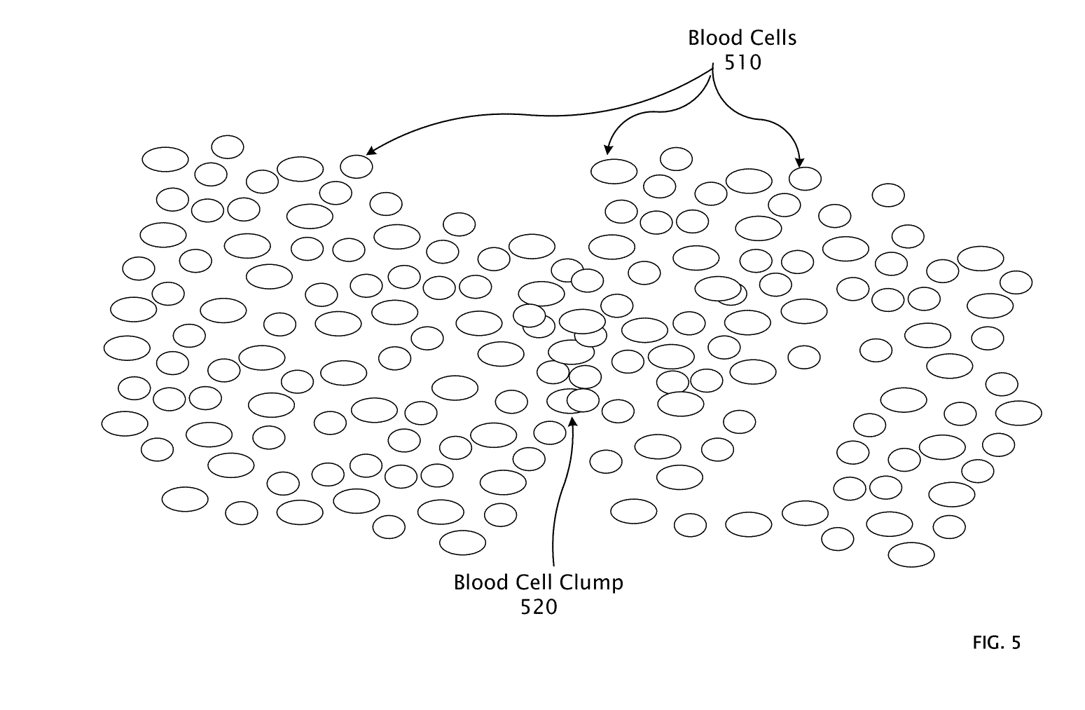

FIG. 5 illustrates a screen shot for an application supporting a Dot Counting Service, according to one embodiment. In this example, an image containing Blood Cells 510 is shown. Blood cells are shown in the image as ovals; in a real image they may be many different shapes. Once each Pixel 410 has been assigned to foreground or background, contiguous groupings of foreground pixels may be counted as Blood Cells 510. Blood Cell Clump 520 may show overlapping cells on the image, which may not be detected as separate cells for counting purposes, resulting in Blood Cell Clump 520 initially being counted as a single cell. In one embodiment, Dot Counting Service may compare the size of each identified shape with a mean size of all of the identified shapes. For example, if a shape is found to exceed a certain percentage of the average size, or if the size exceeds two standard deviations from the mean size, the size of that shape may be divided by the mean size to obtain an estimate of a number of cells in Blood Cell Clump 520.

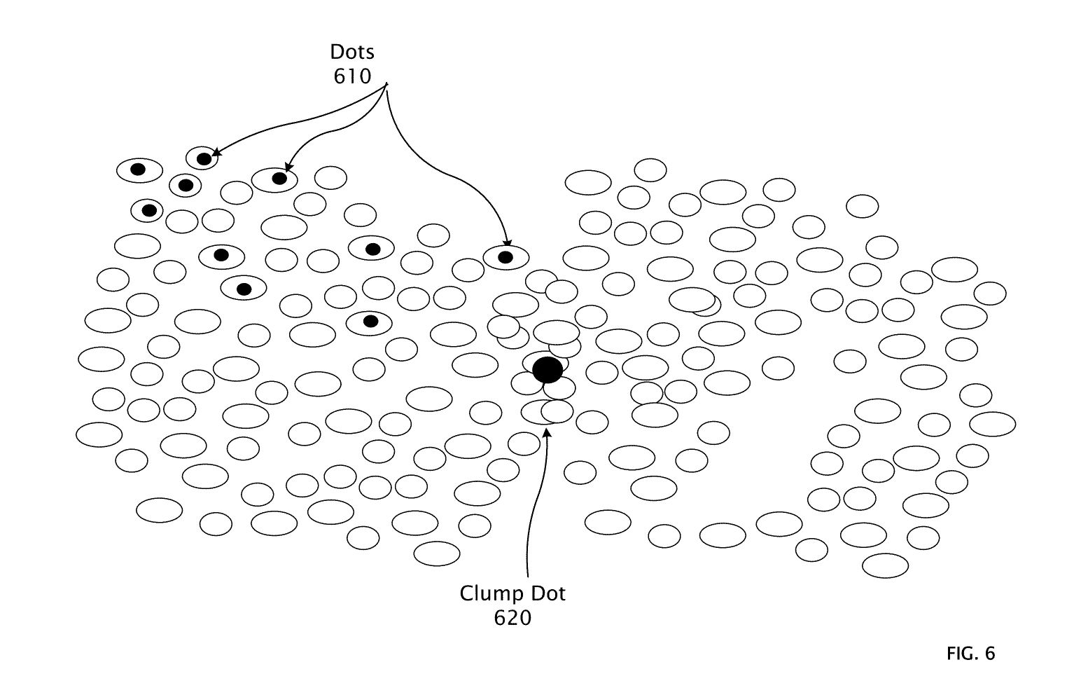

FIG. 6 illustrates a screen shot for an application supporting a Dot Counting Service, according to one embodiment. In this image, Dots 610 are shown indicating some identified foreground shapes. Clump Dot 620 is shown as being a larger dot, indicating that it is representing multiple cells. In one embodiment, hovering over Clump Dot 620 may cause a number indicating an estimated number of cells represented by Clump Dot 620.

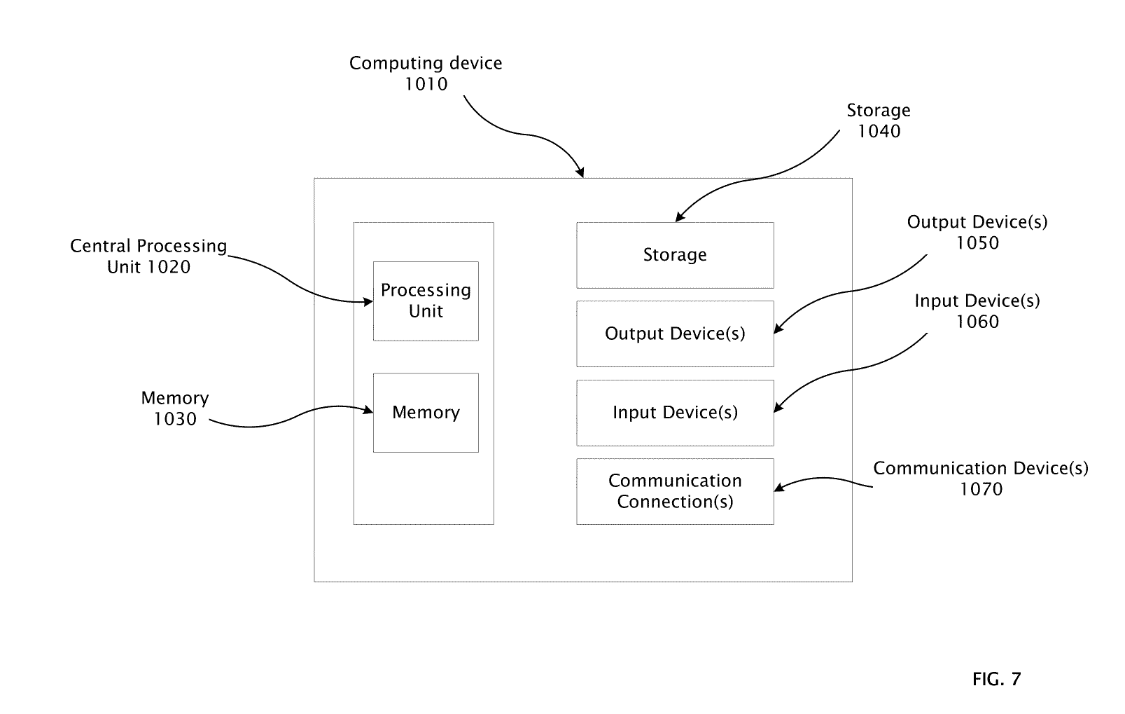

FIG. 7 is a component diagram of a computing device to which a Dot Counting Service process may be applied according to one embodiment. The Computing Device 1010 can be utilized to implement one or more computing devices, computer processes, or software modules described herein, including, for example, but not limited to a server, a mobile device, or the like. In one example, the Computing Device 1010 can be used to process calculations, execute instructions, and receive and transmit digital signals. In another example, the Computing Device 1010 can be utilized to process calculations, execute instructions, receive and transmit digital signals, and compile computer code suitable for a mobile device. The Computing Device 1010 can be any general or special purpose computer now known or to become known capable of performing the steps and/or performing the functions described herein, either in software, hardware, firmware, or a combination thereof.

In its most basic configuration, Computing Device 1010 typically includes at least one Central Processing Unit (CPU) 1020 and Memory 1030. Depending on the exact configuration and type of Computing Device 1010, Memory 1030 may be volatile (such as RAM), non-volatile (such as ROM, flash memory, etc.) or some combination of the two. Additionally, Computing Device 1010 may also have additional features/functionality. For example, Computing Device 1010 may include multiple CPU's. The described methods may be executed in any manner by any processing unit in Computing Device 1010. For example, the described process may be executed by both multiple CPU's in parallel.

Computing Device 1010 may also include additional storage (removable or non-removable) including, but not limited to, magnetic or optical disks or tape. Such additional storage is illustrated in FIG. 4 by Storage 1040. Computer readable storage media include volatile and nonvolatile, removable and non-removable media implemented in any method or technology for storage of information such as computer-readable instructions, data structures, program modules or other data. Memory 1030 and Storage 1040 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 1010. Any such computer-readable storage media may be part of Computing Device 1010. But computer readable storage media do not include transient signals.

Computing Device 1010 may also contain Communications Device(s) 1070 that allow the device to communicate with other devices. Communications Device(s) 1070 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 1010 may also have Input Device(s) 1060 such as keyboard, mouse, pen, voice input device, touch input device, etc. Output Device(s) 1050 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A method, comprising:
receiving an image;
determining a grid of pixels on the image, comprising a plurality of grid sections;
evaluating an attribute of a plurality of pixels in a grid section, giving a minimum and maximum value of the attribute for the grid section, the minimum value representing a background value, and the maximum value representing a foreground value;
determining a threshold value based upon the background value and the foreground value;
assigning each pixel within the grid section as belonging to a foreground or a background, based upon a value of the attribute of the pixel and the threshold value; and
counting a number of shapes formed by contiguous pixels assigned as belonging to the foreground.
